(19) United States
(12) Patent Application Publication
(10) Pub. No.: US 2025/0322072 A1
(43) Pub. Date: Oct. 16, 2025

(54) SECURE FIRMWARE UPDATES USING NONCES

(71) Applicant: Micron Technology, Inc., Boise, ID (US)

(72) Inventor: Zhan LIU, Cupertino, CA (US)

(21) Appl. No.: 19/070,603

(22) Filed: Mar. 5, 2025

Related U.S. Application Data
(60) Provisional application No. 63/632,821, filed on Apr. 11, 2024.

(51) Int. Cl. G06F 21/57; G06F 8/65; H04L 9/32

(52) U.S. Cl. CPC G06F 21/572; G06F 8/65; H04L 9/3242; H04L 9/3247; G06F 2221/033

(57) ABSTRACT

In some implementations, a first device may receive, from a second device, a first nonce associated with initiating a firmware update. The first device may generate, for the firmware update, a second nonce. The first device may transmit, for the firmware update and to the second device, the second nonce based on receiving the first nonce. The first device may receive, for the firmware update and from the second device, a firmware update message that is signed by a digital signature. The first device may verify the firmware update message based on the first nonce, the second nonce, and the digital signature. The first device may perform an action based on verifying the firmware update message.

### CROSS-REFERENCE TO RELATED APPLICATION

This Patent Application claims priority to U.S. Provisional Patent Application No. 63/632,821, filed on Apr. 11, 2024, entitled “SECURE FIRMWARE UPDATES USING NONCES,” and assigned to the assignee hereof. The disclosure of the prior Application is considered part of and is incorporated by reference into this Patent Application.

### TECHNICAL FIELD

The present disclosure generally relates to device security and, for example, secure firmware updates using nonces.

### BACKGROUND

Device security and firmware are components associated with safeguarding the integrity, confidentiality, and/or accessibility of electronic devices across various domains. Device security encompasses multifaceted layers including physical, network, and software security, associated with preventing unauthorized access, misuse, and/or modification of hardware, software, and/or data, among other examples. Authentication mechanisms, such as passwords, biometrics, and/or cryptographic keys may be deployed to verify user identities. Additionally, or alternatively, encryption techniques ensure data confidentiality for data at rest and/or in transit.

Firmware may control and/or manage operations of one or more hardware components. Firmware may be stored in non-volatile memory, such as read-only memory (ROM) or flash memory. Functions such as initializing hardware, managing device resources, and/or facilitating communication between hardware and software, among other examples, may be carried out by and/or controlled via firmware. Secure coding practices, such as input validation and proper memory management, may enable development of resilient firmware to common vulnerabilities, such as buffer overflows and/or format string vulnerabilities, among other examples. Additionally, over-the-air (OTA) updates of firmware enable remote deployment of firmware patches and updates, enhancing device security. However, firmware updates introduce potential security risks, such as unauthorized updates and/or tampering, among other examples.

### BRIEF DESCRIPTION OF THE DRAWINGS

FIGS. 1A-1C are diagrams of an example implementation associated with secure firmware updates using nonces.

FIG. 2 is a diagram of an example environment in which systems and/or methods described herein may be implemented.

FIG. 3 is a diagram of example components of a device associated with secure firmware updates using nonces.

FIG. 4 is a flowchart of an example method associated with secure firmware updates using nonces.

FIG. 5 is a flowchart of an example method associated with secure firmware updates using nonces.

### DETAILED DESCRIPTION

Firmware updates for a device (e.g., a memory device or another device) may improve security by improving the likelihood that the device is protected from malicious attacks. Further, firmware updates may ensure that the device is operating correctly. Traditionally, firmware updates use signatures and/or version numbers to authenticate and validate an update package (e.g., that includes a firmware update). For example, version numbers enable the device to track, identify, and/or verify the integrity and/or authenticity of a firmware update to be installed on the device. In some examples, the device may compare the version number in the update package to a version number of currently installed firmware to authenticate the firmware update. The use of signatures and/or version numbers may be designed to prevent rollback attacks, where an outdated version of firmware with known vulnerabilities could be maliciously reinstated, thereby compromising the security of the device. For example, if a version number of firmware indicated in the update package is lower than a version number of currently installed firmware on the device, then the device may reject the firmware update (e.g., thereby reducing the likelihood of a rollback to previous firmware that may have known vulnerabilities). Additionally, the device may verify the integrity and/or authenticity of a firmware update using one or more encryption techniques, such as an asymmetric key system or a symmetric key system (e.g., where the device verifies a digital signature in the update package using the one or more encryption techniques to verify the integrity and/or authenticity of a firmware update included in the update package).

However, this approach to updating firmware may be associated with one or more challenges. For example, each update package must include a firmware version number to reduce a likelihood of the device being updated with outdated, genuine firmware packages (e.g., that may have known vulnerabilities). The firmware version number may increase monotonically, necessitating a version number check on the device. This check requires a write-protected area to store the firmware number, preventing tampering by attackers. This consumes processing resources, memory resources, and/or hardware resources associated with the write-protected area for firmware number storage and verification. Moreover, the device may need to support a revocation process for updates (e.g., to support the event that a provided update include one or more vulnerabilities) and/or for encryption keys used to verify the digital signatures (e.g., to support the event that an encryption key becomes compromised). To support the revocation process, a revocation list may be used by the device. A revocation list may include one or more firmware versions (e.g., version numbers) that have one or more vulnerabilities, errors, or other issues. When a device verifies a firmware update, the device may check to determine if a firmware version number of the firmware in the update is included in the revocation list. If the firmware version number is included in the revocation list, then the device may reject the update and/or may refrain from installing the firmware in the update. The introduction of a revocation process for firmware updates adds complexity, such as during device boot-up when network connectivity may be absent, thereby increasing the difficulty associated with accessing the revocation lists (e.g., which may be maintained remotely by a firmware vendor or device manufacturer). Local revocation lists may be stored in write-protected areas and securely updated, which may be associated with complex and costly measures (e.g., in terms of computing resources, processing resources, memory resources, and/or hardware components), such as secure commands and/or hardware security modules, among other examples. Therefore, the revocation process for firmware updates may consume processing resources, computing resources, memory resources, and/or network resources, among other examples associated with the device obtaining a revocation list and/or determining whether a firmware version number of firmware included in an update package is included in the revocation list. Additionally, the device may include one or more additional hardware components to support the revocation process, consuming available hardware space which may be limited in the device.

Some implementations described herein enable a secure method for firmware updates that eliminates the need for firmware version numbers and/or revocation processes. For example, a device may receive a first nonce from a server device to initiate a firmware update. As used herein, “nonce” may refer to a “number used once.” For example, a nonce may be a cryptographic term referring to a unique and/or arbitrary value that is employed only once within a given context or cryptographic session (e.g., only once for a firmware update session). A nonce may be a random value. The device may generate a second nonce based on, or in response to, receiving the first nonce. The device may receive a firmware update message. The firmware update message may include a digital signature. The device may verify the firmware update message using a hash function based on both the first nonce and the second nonce and the firmware update message content.

In some aspects, the device may verify the firmware update message by generating a hash function using the first nonce, the second nonce, and the firmware update message. The device may verify the digital signature using a public key associated with the server device to obtain a second hash function. The device may verify the firmware update message based on a comparison of the first hash function and the second hash function. The device may perform an action, such as updating firmware or rejecting the firmware update message, based on the verification results. For example, if the first hash function and the second hash function match, then the device may update the firmware of the device using the firmware included in the firmware update message. If the first hash function and the second hash function do not match, then the device may reject the firmware update message and/or may refrain from updating the firmware of the device using the firmware included in the firmware update message.

In this way, the device and/or the server device may reduce the likelihood of rollback attacks for firmware updates without using firmware version numbers or revocation processes. For example, by using nonce-based verification for each firmware update session, the device and/or the server device may ensure that each update package is fresh and specific to the session, reducing the effectiveness of replay or rollback attacks for firmware updates. For example, because the device (e.g., a device receiving a firmware update message) may generate a new nonce for each firmware update session, the device may be enabled to verify the integrity and/or authenticity for firmware provided during each firmware update session using the nonce created by the device for that firmware update session. For example, if a previous firmware and/or previous nonces (e.g., from a previous update session) are used to update firmware (e.g., by an attacker) in a new firmware update session, the device may identify that the previous firmware is invalid because the firmware update message may include a digital signature that is based on the previous nonces (e.g., rather than the new nonce generated for the new firmware update session). Therefore, revocation processes and/or potential attacks may be reduced, mitigated, or eliminated because firmware update packets may be valid only for a given firmware update session and any attempt to provide previous firmware (e.g., with known vulnerabilities or issues) can be identified by the device using the nonce-based approach described herein.

The device and/or the server device may conserve processing resources and/or memory resources by reducing the overhead associated with managing firmware version numbers and revocation lists. The device may reliably verify the integrity and/or authenticity of firmware updates without a network connection and/or without obtaining a revocation list (e.g., during device boot-up) because the device can use the nonces for a given firmware update session to verify the integrity and/or authenticity of firmware updates provided during the given firmware update session. Additionally, the techniques and implementations described herein may decrease the reliance on write-protected storage areas and hardware security modules of a device, which conserves network resources and reduces the overall device cost and complexity. The techniques and implementations described herein may improve security for firmware updates and provide a streamlined update process that mitigates potential attack vectors associated with traditional versioning and revocation schemes for firmware updates.

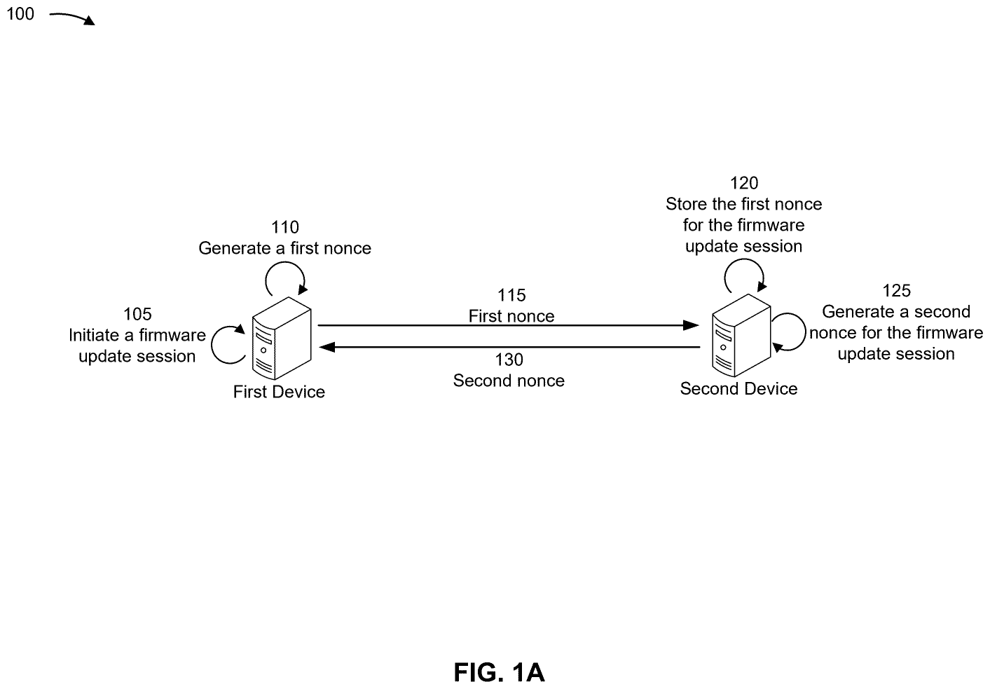

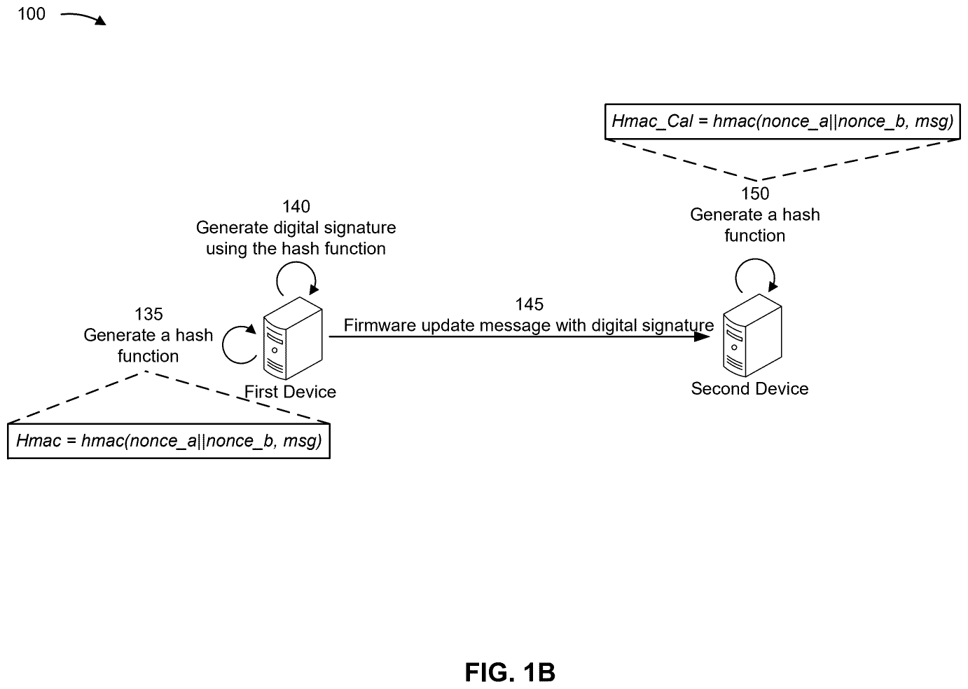

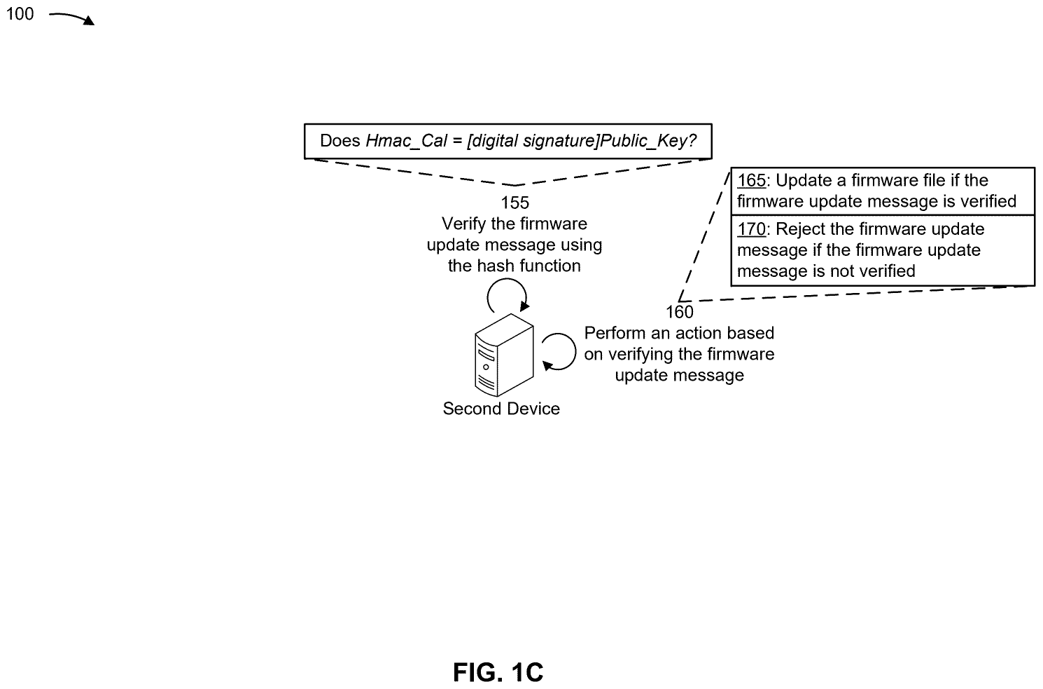

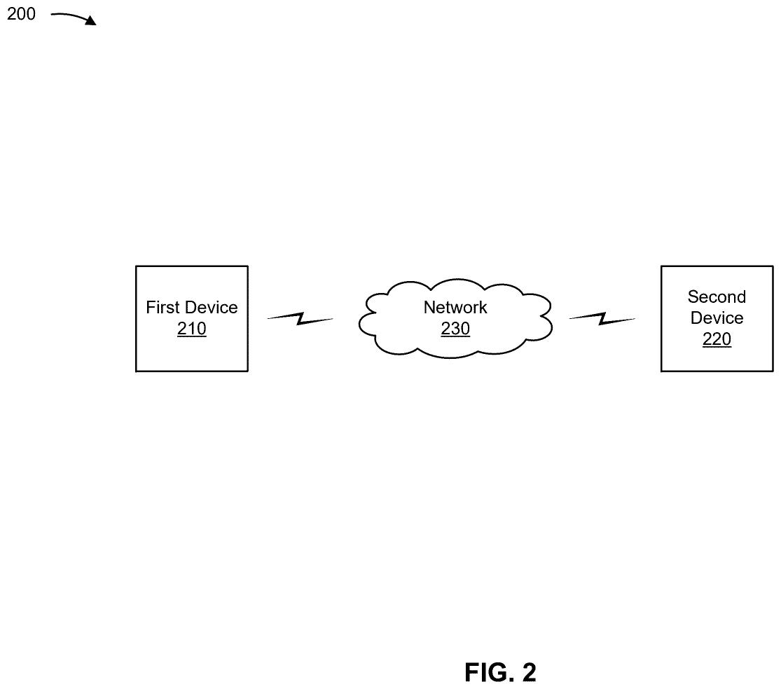

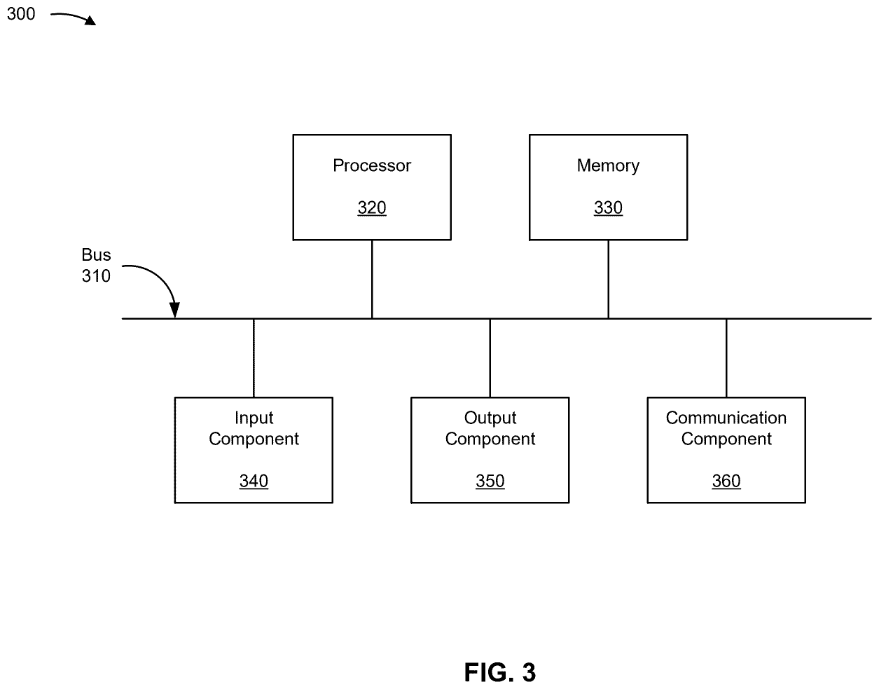

FIGS. 1A-1C are diagrams of an example implementation 100 associated with secure firmware updates using nonces. As shown in FIGS. 1A-1C, example implementation 100 includes a first device and a second device. These devices are described in more detail below in connection with FIG. 2 and FIG. 3. In some aspects, the first device may be a server device (e.g., that manages, configures, and/or provides firmware updates) and the second device may be a device that executes firmware.

As shown in FIG. 1A, and by reference number 105, the first device may initiate a firmware update session for updating firmware of the second device. For example, the first device may obtain a firmware file to be provided to the second device. In some aspects, the first device may obtain the firmware file from another device (not shown in FIG. 1A). For example, the first device and/or the other device may be associated with an entity that manages, configures, and/or otherwise provides firmware for the second device. The entity may be a firmware vendor, a manufacturer of the second device, or another entity.

As shown by reference number 110, the first device may generate a first nonce for the firmware update session. The first device may generate the first nonce based on, or in association with, initiating the firmware update session. For example, the first device may generate the first nonce in response to initiating the firmware update session.

The first device may generate the first nonce using a secure random number generation process. In some aspects, the secure random number generation process may be compliant with one or more industry standards, such as a national institute of standards and technology (NIST) standard (e.g., NIST special publication 800-90A). The secure random number generation process may include the use of a deterministic random bit generator (DRBG) that is seeded with entropy from a trusted source, ensuring the robustness of the nonce against prediction and brute-force attacks. In some aspects, the first device may also receive the first nonce from a third device, associated with initiating a different firmware update session. The third device may be a security device or component associated with the first device. For example, the reception and/or generation of the first nonce may be part of a security protocol to ensure that each firmware update session is unique and secure, preventing replay attacks by ensuring freshness of the session. Additionally, or alternatively, the first device may generate the first nonce via a random number generator within the first device. The random number generator may be a hardware-based and/or software-based component that ensures the generation of a high-entropy nonce, which may be difficult to predict or reproduce by unauthorized entities. The use of the random number generator may improve the security of the nonce exchange between the first device and the second device by making the first nonce more resistant to attacks that rely on predicting nonce values.

In some aspects, the first device may generate the first nonce based on a timestamp. The timestamp may indicate a time at which the first device generates the first nonce. Additionally, or alternatively, the first device may generate the first nonce based on a timestamp and a random number (e.g., a combination of the timestamp and the random number). This may enhance security of the firmware update session because a device (e.g., the second device) verifying or authenticating the firmware update session may leverage the temporal uniqueness of the timestamp to ensure that the first nonce is not only random but also time-sensitive, thereby providing an additional layer of security against potential replay attacks.

As shown by reference number 115, the first device may transmit, and the second device may receive, the first nonce as part of the firmware update session. For example, the first device may transmit, and the second device may receive, the first nonce based on, or otherwise associated with, initiating the firmware update session. For example, the reception of the first nonce from the first device may indicate to the second device that the first device is initiating the firmware update session. In some aspects, the transmission of the first nonce may include a message or other indication that the first device is initiating the firmware update session for the second device.

In some aspects, the transmission of the first nonce from the first device to the second device may be encrypted using a shared secret key to prevent interception by unauthorized parties. For example, the first device may encrypt the first nonce using a secret key. The secret key may be a pre-shared key, a session key, a password-based key, a master key, and/or a key encryption key, among other examples. Encrypting the first nonce via the shared secret key may increase a likelihood that even if the transmission of the first nonce is intercepted by an attacker that the first nonce remains unintelligible to the attacker, thereby increasing the security of the firmware update session.

In some aspects, the transmission of the first nonce may include additional information to further ensure the temporal validity of the nonce. The additional information may include a timestamp and/or a sequence number, among other examples. This additional information can be used by the first device and/or the second device to prevent replay attacks that may occur if an attacker attempts to use a previously captured nonce outside of its valid time window or sequence.

As shown by reference number 120, the second device may store the first nonce for the firmware update session. For example, the second device may store the first nonce in a secure storage location. In some aspects, the second device may temporarily store the first nonce. For example, after an expiration or end of the firmware update session, the second device may delete or remove the first nonce from memory. The second device may store the first nonce in a secure memory location that is resistant to tampering or unauthorized access. By storing the first nonce in a secure memory location, the second device may protect or safeguard the first nonce from potential threats that could compromise the integrity of the firmware update session.

As shown by reference number 125, the second device may generate a second nonce for the firmware update session. For example, the second device may generate the second nonce as a response to receiving the first nonce from the first device. The generation of the second nonce may further contribute to the security of the firmware update session because the second nonce is a second cryptographic feature (e.g., generated by a second, separate, trusted source for the firmware update session) to be used to verify the authenticity of the firmware update session, as described in more detail elsewhere herein. The second device may generate the second nonce in a similar manner as described herein in connection with the first device generating the first nonce, such as in connection with reference number 110. The second device may store the second nonce, in a similar manner (and/or in a similar or the same memory location) as the storage of the first nonce.

Additionally, or alternatively, the second device may generate the second nonce by deriving the second nonce using a cryptographic algorithm that uses the first nonce and other session-specific data as an input. The session-specific data may be data that is based on, or otherwise associated with, the firmware update session. For example, the session-specific data may include an identifier of the first device, an identifier of the second device, an identifier of the firmware update session, and/or a timestamp, among other examples. Generating the second nonce in this manner may ensure that the second nonce is intrinsically linked to the specific firmware update session, the first nonce, and/or the first device, thereby enhancing the overall security of the nonce exchange.

As shown by reference number 130, the second device may transmit, and the first device may receive, the second nonce. For example, the second device may transmit, to the first device, the second nonce for the firmware update session based on receiving the first nonce. In some aspects, this transmission of the second nonce to the first device may complete a nonce exchange for the firmware update session. The nonce exchange may enable both devices to have a shared understanding of the nonces used for the session.

Additionally, or alternatively, the transmission of the second nonce may be secured using encryption techniques, such as symmetric encryption with a session key or asymmetric encryption with a public key associated with the first device. For example, the second device may encrypt the second nonce using the secret key, in a similar manner as described herein in connection with the first device encrypting the first nonce. For example, the first nonce and the second nonce may be encrypted using the secret key. The transmission of the second nonce may include an encrypted version of the second nonce (e.g., that is encrypted using the secret key). The first device may decrypt the encrypted version of the second nonce to obtain the second nonce. This improves a likelihood that the second nonce is protected during transit and cannot be obtained or manipulated by unauthorized parties.

The first device may receive, for the firmware update session and from the second device, the second nonce based on transmitting the first nonce. In some aspects, the exchange of nonces between the first and second devices establishes a secure communication channel for the firmware update session, where both devices contribute to the uniqueness of the firmware update session. Because both devices (e.g., the first device and the second device) contribute to establishing the uniqueness of the firmware update session, the security of the firmware update session may be improved because either device may be able to independently verify and/or authenticate the firmware update session, as described in more detail elsewhere herein.

Additionally, or alternatively, the transmission of the second nonce to the first device may include session metadata, such as a session identifier, an identifier of the second device, and/or a timestamp, among other examples. This may further ensure the uniqueness of the session because the session metadata may be tied to, or be specific to, the firmware update session. The first device may use the session metadata to confirm that the second device is intended to be included in the firmware update session. The inclusion of session metadata provides an additional layer of validation, ensuring that the nonce is not only unique but also contextually relevant to the specific firmware update session.

As shown in FIG. 1B, and by reference number 135, the first device may generate a hash function using the first nonce and the second nonce. For example, the first device may generate a hash function (shown as Hmac in FIG. 1B) based on the first nonce (shown as nonce_a in FIG. 1B), the second nonce (shown as nonce_b in FIG. 1B), and a firmware update message (shown as msg in FIG. 1B). The first device may obtain the first nonce from a storage location or memory of the first device. The first device may receive the second nonce from the second device, as described elsewhere herein. The firmware update message may be a text file or a firmware file used to update firmware for the second device.

In some aspects, the first device may encrypt the firmware update message (e.g., using a private key or another encryption technique) to obtain an encrypted version of the firmware update message (e.g., encrypted text). In some aspects, the first device may generate the hash function using the encrypted version of the firmware update message (e.g., rather than the unencrypted version of the firmware update message). This may improve the security of the firmware update session because the cryptographic information used to encrypt the firmware update message (e.g., a private key) may be needed to generate a hash function that will be validated by the second device.

In some aspects, the hash function may be a hash message authentication code (HMAC). The first device may calculate the HMAC as the hash function. The HMAC may be based on a combination of the first nonce, the second nonce, and the firmware update message (or an encrypted version of the firmware update message) to be communicated via the firmware update session. The hash function generation ensures a freshness and uniqueness of the firmware update session, thereby reducing the effectiveness of replay attacks by requiring new nonces for each firmware update session. In some aspects, the hash function may be further based on the secret key used to encrypt the nonces, thereby enhancing the security of the process (e.g., because a malicious actor may be able to intercept the first nonce and/or the second nonce, but may not have access to the secret key). Additionally, or alternatively, the first device may generate the hash function using a combination of the first nonce, the second nonce, the firmware update message, and additional session metadata associated with the firmware update session. As described elsewhere herein, the session metadata may include an identifier of the firmware update session, an identifier of the first device, an identifier of the second device, and/or a timestamp, among other examples. The inclusion of additional session metadata into the generation of the hash function can provide further context and security parameters that are unique to the firmware update session, thereby strengthening the validation process and/or improving the security of the firmware update process.

In some aspects, the hash function may serve as a basis for creating a digital signature that will be used by the second device to authenticate the firmware update message ensuring that the firmware update message is valid, has not been tampered with, and/or is from a legitimate source, as described in more detail elsewhere herein. In some aspects, the hash function may be generated using a cryptographic hash algorithm, such as secure hash algorithm (SHA)-256 or SHA-3, among other examples, which may be associated with strong collision resistance and preimage resistance properties. However, it should be understood that different types of hash functions may be used based on the security requirements of the firmware update process and/or the computational capabilities of the first device and/or the second device.

As shown by reference number 140, the first device may generate a digital signature for a firmware update message using the hash function. For example, the first device may generate the digital signature using the hash function and one or more encryption techniques. For example, the first device may generate the digital signature using the hash function and a private key. In some aspects, the private key may be a different private key than a private key used to encrypt the firmware update message. In other aspects, the private key may be the private key used to encrypt the firmware update message.

In some aspects, the digital signature provides a means for the second device to verify the authenticity and integrity of the firmware update message, as described in more detail elsewhere herein. Additionally, or alternatively, the first device may generate the digital signature using a digital signature algorithm, such as Rivest-Shamir-Adleman (RSA), elliptic-curve cryptography (ECC), elliptic-curve digital signature algorithm (ECDSA), or Edwards-curve digital signature algorithm (EdDSA), among other examples. The described digital signature techniques are provided as examples and other types of digital signatures may be used. The selection of the digital signature algorithm may be based on one or more factors, such as the level of security, the performance characteristics of the first device and/or the second device (e.g., the computational capabilities of the first device and/or the second device), and/or compatibility with existing infrastructure for the firmware update process, among other examples.

As shown by reference number 145, the first device may transmit, and the second device may receive, the firmware update message with the digital signature. The firmware update message may be signed by the digital signature. For example, the first device may transmit, and the second device may receive, the firmware update message that is encrypted by the digital signature for the firmware update session. In some aspects, the firmware update message may be encrypted (e.g., as described herein) and signed using the digital signature. The encrypted firmware update message may improve the likelihood that only the intended recipient (e.g., the second device) can decrypt and use the message, providing confidentiality and security for the firmware update process.

Additionally, or alternatively, the firmware update message may be transmitted over a secure communication channel, such as a transport layer security (TLS) channel, an internet protocol security (IPSec) channel, and/or an encrypted tunnel, among other examples. The use of a secure communication channel may provide additional security features for the firmware update session, such as channel encryption, data integrity, and/or endpoint authentication, among other examples. This layered security approach may improve the security of the firmware update message from various threats, such as eavesdropping, man-in-the-middle attacks, and/or unauthorized access, among other examples. The transmission of the firmware update message with the digital signature may enable the second device to perform verification of the firmware update message using the digital signature before proceeding with a firmware update (e.g., using the firmware update message), as described in more detail elsewhere herein.

As shown by reference number 150, the second device may generate a hash function using the firmware update message (e.g., shown as Hmac_Cal in FIG. 1B). The second device may generate the hash function using the first nonce (shown as nonce_a in FIG. 1B), the second nonce (shown as nonce_b in FIG. 1B), and the firmware update message (shown as msg in FIG. 1B). For example, the second device may obtain the first nonce and the second nonce from a storage location and/or memory of the second device. The second device may obtain the firmware update message via the communication received from the first device. In some aspects, the second device may decrypt the firmware update message (e.g., if encrypted) before using the firmware update message to generate the hash function.

The second device may generate the hash function in a similar manner as described elsewhere herein. For example, the second device may generate the hash function in a similar manner as described in connection with reference number 135. The hash function generated or calculated by the second device may be an HMAC or another hash function. For example, the second device may independently calculate a separate hash function using the same components as the first device (e.g., the first nonce, the second nonce, and the firmware update message) where the source of the components (e.g., the first nonce and the second nonce) is a storage location and/or memory of the second device.

As shown in FIG. 1C, and by reference number 155, the second device may verify or validate the firmware update message using the hash function generated by the second device. For example, the second device may verify the firmware update message using the hash function and the digital signature, where the hash function is based on the first nonce, the second nonce, and the firmware update message, as described herein. This verification process ensures that the firmware update message is valid, is from the first device, and/or has not been altered during transmission, among other examples.

For example, the hash function calculated by the second device may be compared to the decrypted hash function from the digital signature to verify the integrity and authenticity of the firmware update message. If the hash functions match, then the firmware update message is verified, and the second device can proceed to update a firmware file using the message. If they do not match, then the firmware update message may be rejected, thereby preventing any unauthorized or outdated firmware updates. For example, the second device may decrypt the digital signature using a public key associated with the first device to obtain a second hash function. The second device may verify the firmware update message based on a comparison of the first hash function to the second hash function. In some aspects, the firmware update message is verified if the first hash function matches the second hash function. Alternatively, the firmware update message may not be verified if the first hash function does not match the second hash function.

Additionally, or alternatively, the second device may use other cryptographic techniques, such as symmetric key decryption, if a shared secret key is used between the first device and the second device. This may streamline the verification process when a secure channel with a shared secret key is already established, simplifying the cryptographic operations required. Furthermore, the second device may utilize alternative hash functions or HMACs for generating and verifying the hash function, offering flexibility in the cryptographic methods used and potentially enhancing security through the use of more advanced or specialized algorithms.

In some aspects, the second device may perform additional checks such as validating the certificate chain of the digital signature to ensure that the signing key is trusted and has not been revoked. This certificate validation process can involve checking against a certificate revocation list (CRL) or using the Online Certificate Status Protocol (OCSP) to obtain the current revocation status of the signing certificate.

As shown by reference number 160, the second device may perform an action based on verifying the firmware update message. For example, as shown by reference number 165, the second device may proceed with updating a firmware file using the firmware update message if the firmware update message is verified. Alternatively, as shown by reference number 170, the second device may reject the firmware update message if the firmware update message is not verified.

In some aspects, this conditional action ensures that only verified and authentic firmware updates are applied to, or installed by, the second device, thereby maintaining the security and integrity of the firmware of the second device. Additionally, or alternatively, if the firmware update message is verified, the second device may also perform additional actions, such as logging an update event, notifying a user or system administrator of the successful update, and/or restarting the second device to apply the new firmware, among other examples.

If the firmware update message is not verified, the second device may take actions, such as alerting the user or system administrator of the failed verification, preserving the current firmware version, and/or initiating a security protocol to investigate the source of the invalid firmware update message, among other examples. These additional actions can provide a comprehensive response to the firmware update process, ensuring that the security of the second is maintained and that any potential threats are addressed promptly.

Additionally, or alternatively, if the firmware update message is not verified, the second device may take one or more actions, such as quarantining the message, initiating a security audit, and/or alerting a monitoring system to the attempted update, among other examples. These action(s) may enable the second device to isolate a suspicious firmware update message and engage security protocols to investigate and respond to the incident. Furthermore, the second device may implement a fallback mechanism where, if the firmware update message is not verified, the second device may request a new firmware update message or initiate a new firmware update session with the first device, thereby ensuring continuity in the firmware update process while maintaining security standards.

As an example, a malicious actor or attacker may obtain an old or outdated firmware update message (e.g., the firmware update message or a new firmware update message signed using the digital signature described above at a later date after the digital signature has already been used for a firmware update session). The malicious actor or attacker may attempt to provide the invalid firmware update message to the second device using security information from the old firmware update session (e.g., the first nonce and the second nonce). In such examples, the malicious actor or attacker may transmit, and the second device may receive, the first nonce to initiate a firmware update session, in a similar manner as described above. However, the second device may generate a third nonce for the firmware update session because the second device may be configured to generate a new or unique nonce for each firmware update session. The malicious actor or attacker may transmit, and the second device may receive, the firmware update message signed using the digital signature described above (e.g., where the digital signature is based on the first nonce, the second nonce, and the firmware update message).

The second device may attempt to verify the firmware update message by generating a hash function using the firmware update message, the first nonce, and the third nonce. Because the digital signature of the old or outdated firmware update message is based on the first nonce, the second nonce, and the firmware update message, the hash function generated (e.g., calculated) by the second device (e.g., that is based on the firmware update message, the first nonce, and the third nonce) will not match the hash function obtained via the digital signature. As a result, the second device may be enabled to identify that the firmware update message is not valid and/or not authentic and reject the firmware update message. In this way, a firmware version number and/or revocation process (e.g., one or more revocation lists) are not needed to enable the second device to reliably verify firmware update messages, thereby reducing the complexity and/or increasing the efficiency of the firmware update process.

Additionally, or alternatively, the techniques and implementations described herein may provide measures to prevent rollback attacks by ensuring that only the firmware updates for valid firmware update sessions are accepted or installed by a device (e.g., the second device).

As indicated above, FIGS. 1A-1C are provided as an example. Other examples may differ from what is described with regard to FIGS. 1A-1C.

FIG. 2 is a diagram of an example environment 200 in which systems and/or methods described herein may be implemented. As shown in FIG. 2, environment 200 may include a first device 210, a second device 220, and a network 230. Devices of environment 200 may interconnect via wired connections, wireless connections, or a combination of wired and wireless connections.

The first device 210 may include one or more devices capable of receiving, generating, storing, processing, providing, and/or routing information associated with secure firmware updates using nonces, as described elsewhere herein. The first device 210 may be a device that generates, provides, initiates, and/or transmits a firmware update for another device, such as the second device 220. The first device 210 may include a communication device and/or a computing device. For example, the first device 210 may include a server, such as an application server, a client server, a web server, a database server, a host server, a proxy server, a virtual server (e.g., executing on computing hardware), or a server in a cloud computing system. In some implementations, the first device 210 may include computing hardware used in a cloud computing environment.

The second device 220 may include one or more devices capable of receiving, generating, storing, processing, and/or providing information associated with secure firmware updates using nonces, as described elsewhere herein. The first device 210 may be a device that receives, obtains, and/or verifies a firmware update received from another device, such as the first device 210. The second device 220 may include a communication device and/or a computing device. For example, the second device 220 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device. The second device 220 may be configured to execute firmware to perform one or more operations, such as one or more operations associated with hardware of the second device 220.

In some implementations, the second device 220 may be a memory device or a memory system (e.g., that includes one or more memory devices). The second device 220 may be, or may be included in, any electronic device configured to store data in memory. For example, the second device 220 may be, or may be included in, a computer, a mobile phone, a wired or wireless communication device, a network device, a server, a device in a data center, a device in a cloud computing environment, a vehicle (e.g., an automobile or an airplane), and/or an Internet of Things (IoT) device. In some implementations, the second device 220 may be any electronic device or apparatus configured to store data in memory. For example, the second device 220 may be a hard drive, a solid-state drive (SSD), a flash memory system (e.g., a not-and (NAND) flash memory system or a not-or (NOR) flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The network 230 may include one or more wired and/or wireless networks. For example, the network 230 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 230 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with secure firmware updates using nonces. The device 300 may correspond to the first device 210 and/or the second device 220. In some implementations, the first device 210 and/or the second device 220 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include RAM, read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

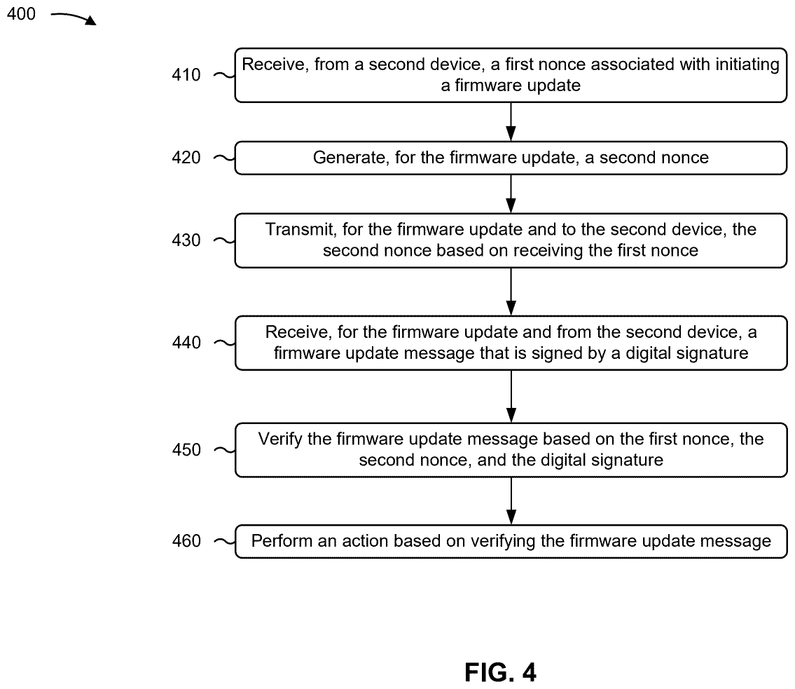

FIG. 4 is a flowchart of an example method 400 associated with secure firmware updates using nonces. In some implementations, a first device (e.g., the second device 220) may perform or may be configured to perform the method 400. In some implementations, another device or a group of devices separate from or including the first device (e.g., the first device 210) may perform or may be configured to perform the method 400. Additionally, or alternatively, one or more components of the first device (e.g., the processor 320, the memory 330, the input component 340, the output component 350, and/or the communication component 360) may perform or may be configured to perform the method 400. Thus, means for performing the method 400 may include the first device and/or one or more components of the first device. Additionally, or alternatively, a non-transitory computer-readable medium may store one or more instructions that, when executed by the first device, cause the first device to perform the method 400.

As shown in FIG. 4, the method 400 may include receiving, from a second device, a first nonce associated with initiating a firmware update (block 410). As further shown in FIG. 4, the method 400 may include generating, for the firmware update, a second nonce (block 420). As further shown in FIG. 4, the method 400 may include transmitting, for the firmware update and to the second device, the second nonce based on receiving the first nonce (block 430). As further shown in FIG. 4, the method 400 may include receiving, for the firmware update session and from the second device, a firmware update message that is signed by a digital signature (block 440). As further shown in FIG. 4, the method 400 may include verifying the firmware update message based on the first nonce, the second nonce, and the digital signature (block 450). As further shown in FIG. 4, the method 400 may include performing an action based on verifying the firmware update message (block 460).

The method 400 may include additional aspects, such as any single aspect or any combination of aspects described below and/or described in connection with one or more other methods or operations described elsewhere herein.

In a first aspect, the method 400 includes generating a first hash function using the first nonce, the second nonce, and the firmware update message, decrypting the digital signature using a public key associated with the second device to obtain a second hash function, and verifying the firmware update message based on a comparison of the first hash function to the second hash function.

In a second aspect, alone or in combination with the first aspect, the firmware update message is verified if the first hash function matches the second hash function or is not verified if the first hash function does not match the second hash function.

In a third aspect, alone or in combination with one or more of the first and second aspects, the method 400 includes updating a firmware file of the first device using the firmware update message if the firmware update message is verified, or rejecting the firmware update message if the firmware update message is not verified.

In a fourth aspect, alone or in combination with one or more of the first through third aspects, the first nonce and the second nonce are encrypted using a secret key, and wherein the first hash function is further based on the secret key.

In a fifth aspect, alone or in combination with one or more of the first through fourth aspects, the first hash function is a hash-based message authentication code.

In a sixth aspect, alone or in combination with one or more of the first through fifth aspects, the method 400 includes receiving, from a third device, the first nonce associated with initiating a different firmware update, generating a third nonce for the different firmware update, and transmitting, for the different firmware update and to the third device, the third nonce, wherein the first nonce and the third nonce are used for verification during the different firmware update.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

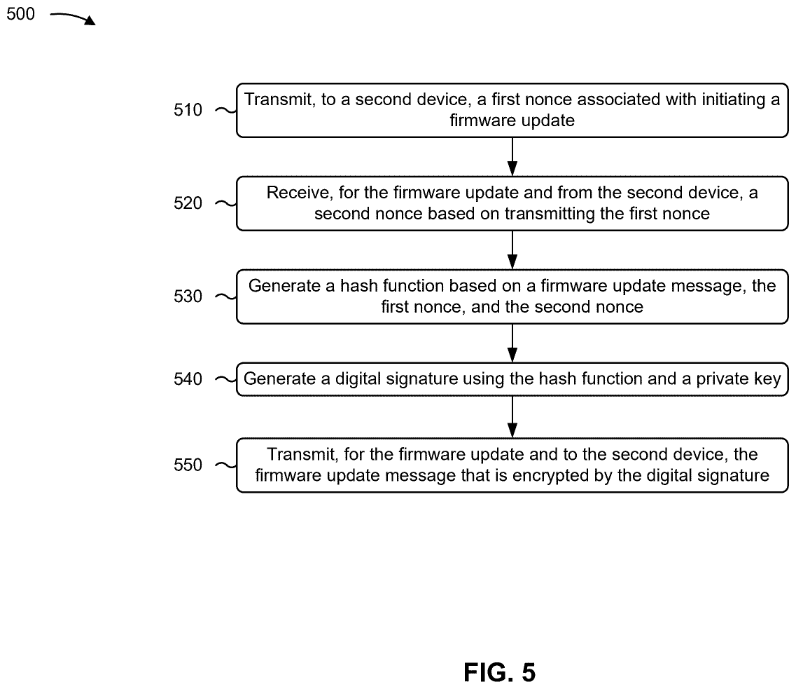

FIG. 5 is a flowchart of an example method 500 associated with secure firmware updates using nonces. In some implementations, a first device (e.g., the first device 210) may perform or may be configured to perform the method 500. In some implementations, another device or a group of devices separate from or including the first device (e.g., the second device 220) may perform or may be configured to perform the method 500. Additionally, or alternatively, one or more components of the first device (e.g., the processor 320, the memory 330, the input component 340, the output component 350, and/or the communication component 360) may perform or may be configured to perform the method 500. Thus, means for performing the method 500 may include the first device and/or one or more components of the first device. Additionally, or alternatively, a non-transitory computer-readable medium may store one or more instructions that, when executed by the first device, cause the first device to perform the method 500.

As shown in FIG. 5, the method 500 may include transmitting, to a second device, a first nonce associated with initiating a firmware update (block 510). As further shown in FIG. 5, the method 500 may include receiving, for the firmware update and from the second device, a second nonce based on transmitting the first nonce (block 520). As further shown in FIG. 5, the method 500 may include generating a hash function based on a firmware update message, the first nonce, and the second nonce (block 530). As further shown in FIG. 5, the method 500 may include generating a digital signature using the hash function and a private key (block 540). As further shown in FIG. 5, the method 500 may include transmitting, for the firmware update and to the second device, the firmware update message that is encrypted by the digital signature (block 550).

The method 500 may include additional aspects, such as any single aspect or any combination of aspects described below and/or described in connection with one or more other methods or operations described elsewhere herein.

In a first aspect, the method 500 includes generating the first nonce in association with initiating the firmware update session.

In a second aspect, alone or in combination with the first aspect, the first nonce and the second nonce are encrypted using a secret key, and wherein the hash function is further based on the secret key.

In a third aspect, alone or in combination with one or more of the first and second aspects, the hash function is a hash-based message authentication code.

In a fourth aspect, alone or in combination with one or more of the first through third aspects, the first device is a server device and the second device is a memory device.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

In some implementations, a first device (e.g., the second device 220) includes one or more components configured to: receive, from a second device (e.g., the first device 210), a first nonce associated with initiating a firmware update; generate, for the firmware update, a second nonce; transmit, for the firmware update and to the second device, the second nonce based on receiving the first nonce; receive, for the firmware update and from the second device, a firmware update message that is signed by a digital signature; verify the firmware update message based on the first nonce, the second nonce, and the digital signature; and perform an action based on verifying the firmware update message.

In some implementations, a first device (e.g., the first device 210) includes one or more components configured to: transmit, to a second device (e.g., the second device 220), a first nonce associated with initiating a firmware update; receive, for the firmware update and from the second device, a second nonce based on transmitting the first nonce; generate a hash function based on a firmware update message, the first nonce, and the second nonce; generate a digital signature using the hash function and a private key; and transmit, for the firmware update and to the second device, the firmware update message that is encrypted by the digital signature.

In some implementations, a method performed by a first device (e.g., the second device 220) includes receiving, from a second device (e.g., the first device 210), a first nonce associated with initiating a firmware update; generating, for the firmware update, a second nonce; transmitting, for the firmware update and to the second device, the second nonce based on receiving the first nonce; receiving, for the firmware update and from the second device, a firmware update message that is signed by a digital signature; verifying the firmware update message based on the first nonce, the second nonce, and the digital signature; and performing an action based on verifying the firmware update message.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first device, comprising:
one or more components configured to:
receive, from a second device, a first nonce associated with initiating a firmware update;
generate, for the firmware update, a second nonce;
transmit, for the firmware update and to the second device, the second nonce based on receiving the first nonce;
receive, for the firmware update and from the second device, a firmware update message that is signed by a digital signature;
verify the firmware update message based on the first nonce, the second nonce, and the digital signature; and
perform an action based on verifying the firmware update message.

2. The first device of claim 1, wherein the one or more components, to verify the firmware update message, are configured to:
generate a first hash function using the first nonce, the second nonce, and the firmware update message;
decrypt the digital signature using a public key associated with the second device to obtain a second hash function; and
verify the firmware update message based on a comparison of the first hash function to the second hash function.

3. The first device of claim 2, wherein the firmware update message is verified if the first hash function matches the second hash function or is not verified if the first hash function does not match the second hash function.

4. The first device of claim 2, wherein the first hash function and the second hash function are hash-based message authentication codes.

5. The first device of claim 1, wherein the one or more components, to perform the action, are configured to:
update a firmware file of the first device using the firmware update message if the firmware update message is verified, or
reject the firmware update message if the firmware update message is not verified.

6. The first device of claim 1, wherein the first nonce and the second nonce are encrypted using a secret key, and
wherein verifying the firmware update message is further based on the secret key.

7. The first device of claim 1, wherein the one or more components are further configured to:
receive, from a third device, the first nonce associated with initiating a different firmware update;
generate a third nonce for the different firmware update; and
transmit, for the different firmware update session and to the third device, the third nonce,
wherein the first nonce and the third nonce are used for verification during the different firmware update.

8. A first device, comprising:
one or more components configured to:
transmit, to a second device, a first nonce associated with initiating a firmware update;
receive, for the firmware update and from the second device, a second nonce based on transmitting the first nonce;
generate a hash function based on a firmware update message, the first nonce, and the second nonce;
generate a digital signature using the hash function and a private key; and
transmit, for the firmware update and to the second device, the firmware update message that is encrypted by the digital signature.

9. The first device of claim 8, wherein the one or more components are further configured to:
generate the first nonce in association with initiating the firmware update.

10. The first device of claim 8, wherein the first nonce and the second nonce are encrypted using a secret key, and
wherein the hash function is further based on the secret key.

11. The first device of claim 8, wherein the hash function is a hash-based message authentication code.

12. The first device of claim 8, wherein the first device is a server device and the second device is a memory device.

13. A method performed by a first device, comprising:
receiving, from a second device, a first nonce associated with initiating a firmware update;
generating, for the firmware update, a second nonce;
transmitting, for the firmware update and to the second device, the second nonce based on receiving the first nonce;
receiving, for the firmware update and from the second device, a firmware update message that is signed by a digital signature;
verifying the firmware update message based on the first nonce, the second nonce, the digital signature; and
performing an action associated with the firmware update message based on verifying the firmware update message.

14. The method of claim 13, wherein verifying the firmware update message comprises:
generating a first hash function using the first nonce, the second nonce, and the firmware update message;
decrypting the digital signature using a public key associated with the second device to obtain a second hash function; and
verifying the firmware update message based on a comparison of the first hash function to the second hash function.

15. The method of claim 14, wherein the firmware update message is verified if the first hash function matches the second hash function or is not verified if the first hash function does not match the second hash function.

16. The method of claim 14, wherein the first hash function is a hash-based message authentication code.

17. The method of claim 13, wherein performing the action comprises:
updating firmware file of the first device using the firmware update message if the firmware update message is verified, or
rejecting the firmware update message if the firmware update message is not verified.

18. The method of claim 13, wherein the first nonce and the second nonce are encrypted using a secret key, and
wherein verifying the firmware update message is further based on the secret key.

19. The method of claim 13, further comprising:
receiving, from a third device, the first nonce associated with initiating a different firmware update;
generating a third nonce for the different firmware update; and
transmitting, for the different firmware update and to the third device, the third nonce,
wherein the first nonce and the third nonce are used for verification during the different firmware update.

20. The method of claim 13, wherein the second device is a server device.
